(19) United States
(12) Patent Application Publication
(10) Pub. No.: US 2026/0155685 A1
(43) Pub. Date: Jun. 4, 2026

(54) STATOR ASSEMBLY OF A MOTOR

(71) Applicant: FENG-TIEN CHEN, TAICHUNG CITY (TW)

(72) Inventor: FENG-TIEN CHEN, TAICHUNG CITY (TW)

(21) Appl. No.: 18/966,679

(22) Filed: Dec. 3, 2024

(51) Int. Cl. H02K 1/16; H02K 3/02; H02K 3/28; H02K 11/20; H02K 15/026

(52) U.S. Cl. CPC H02K 1/165; H02K 3/02; H02K 3/28; H02K 11/20; H02K 15/026

(57) ABSTRACT

A stator assembly of a motor includes a stator core and a stator winding unit. The unit includes a first copper winding and a second aluminum winding. The first winding has a higher rated output power and connects directly to the power source. The second winding, with lower rated output power, connects via a switching device. During startup, the switch closes, combining both windings'output powers. Once the motor reaches a set speed, the switch opens, leaving the power source connected only to the first winding, operating at its rated output power.

### FIELD

The disclosure relates to motors, and particularly to a stator assembly of a motor, wherein not only the manufacturing cost of the motor is reduced, but also the energy consumption during motor operation is decreased.

### BACKGROUND

Reducing manufacturing costs and improving energy efficiency during motor operation have always been critical challenges. U.S. Pat. No. 4,417,192 addresses these challenges by introducing a sectional winding design for three-phase motors. In this design, the winding for each phase is divided into two sections. The first section is connected to the power source during motor startup, while the second section is engaged after the motor reaches operational speed. This configuration reduces the starting current and minimizes the risk of thermal overload. However, it does not significantly reduce manufacturing costs or enhance energy efficiency during continuous operation.

Moreover, U.S. Pat. No. 10,122,240 discloses an electricity generation device with low power consumption. The device requires only a low current input to remain operational and consists of a first motor and a second motor. During operation, electricity is initially supplied to the first motor to drive a flywheel. Once the flywheel reaches a certain rotational speed, electricity is supplied to the second motor to sustain operation. However, this approach neither reduces the manufacturing cost of the motor nor significantly improves energy efficiency.

In addition, U.S. Pat. No. 11,936,258 discloses a method for controlling the outputs of multiple motors. This method involves providing at least one motor with a stator winding selected from a first winding group, a second winding group, a third winding group, and a fourth winding group. The first winding group includes a primary winding with a first rated power and a secondary winding with a second rated power, which is smaller than the first rated power. While this method describes a motor configuration with multiple winding sets designed to operate at different output power levels, its primary purpose is to enable the motor to function in various output modes. Consequently, this approach does not effectively reduce motor manufacturing costs or significantly lower energy consumption during operation.

### SUMMARY

Currently, experts in motor technology do not consider it a pressing issue to simultaneously reduce motor manufacturing costs and decrease energy consumption during motor operation. The present inventor, however, has recognized that motors in the prior art consume more energy during startup than during normal operation. Consequently, their structure must be designed to accommodate the high energy demand of the startup phase. Such a design, however, is not conducive to energy conservation. Furthermore, the stator windings of these motors are typically made of copper, the cost of which has significantly increased in recent times.

Thus, in one aspect of the present disclosure, energy consumption during motor operation is decreased, and manufacturing costs are reduced by employing a stator assembly comprising a stator core, a stator winding unit installed therein to generate kinetic energy in cooperation with a rotor of a motor, and a first switching device. The stator winding unit comprises a first winding and a second winding. The first winding is electrically connected to an AC power source and includes a first electrical conductor with a first electrical conductivity, and a first rated output power under given conditions. The second winding is electrically connected to an AC power source via the first switching device and includes a second electrical conductor with a second electrical conductivity smaller than the first electrical conductivity, and a second rated output power equal to or smaller than the first rated output power under the same given conditions. During the motor's startup phase, the first switching device is closed, connecting both the first and second windings to the AC power source, thereby combining their rated output powers as the motor's total output. Once the motor reaches a predetermined speed, the first switching device opens, leaving the AC power source connected only to the first winding, allowing the motor to operate at its first rated output power.

The stator winding unit described in this disclosure can be applied to the main winding and/or the auxiliary/start winding of single-phase motors, as well as to the phase windings of polyphase motors.

In specific embodiments of the invention, the first electrical conductor comprises copper materials, while the second electrical conductor comprises aluminum materials. Additionally, in certain embodiments, the first rated output power of the first winding equals the rated output power of the motor.

The stator assembly may further include an electrical control unit. The electrical control unit has an input end connected to the AC power source and an output end with a first branch connected to the first winding and a second branch connected to the second winding via the first switching device.

In specific embodiments, the stator assembly may further include an inverter, a second switching device, and a third switching device. The inverter's input end is connected to the third switching device, while its output end is connected to the first winding. The second switching device is positioned between the first winding and the AC power source, and the third switching device is situated between the inverter and the AC power source. During the motor's startup phase, the first and second switching devices are closed, and the third switching device is open, connecting both the first and second windings to the AC power source. This configuration combines the rated output powers of the first and second windings to serve as the motor's total output. Once the motor reaches a predetermined speed, the first and second switching devices open, and the third switching device closes, connecting the AC power source to the first winding via the inverter. This arrangement enables the motor to operate under the inverter's control for improved efficiency and performance.

According to another aspect of the present disclosure, a method is provided for assembling a stator assembly of a motor. The method comprises the following steps:
providing a stator core,
selecting a stator winding unit installed in the stator,
providing a first switching device,
wherein the stator winding unit comprises:
   a first winding including first electrical conductors with a first electric electrical conductivity and a first rated output power under given conditions,
   a second winding including second electrical conductors with a second electrical conductivity lower than the first electrical conductivity and a second rated output power lower than or equal to the first rated output power under the same given conditions,
electrically connecting the first winding to an AC power source, and
electrically connecting the second winding to the AC power source via the first switching device.

In specific embodiments, the method may further comprise the following steps:
providing an inverter,
providing a second switching device,
providing a third switching device,
electrically connecting the first winding to the AC power source via the second switching device,
electrically connecting the first winding to an output end of the inverter, and
electrically connecting an input end of the inverter to the AC power source via the third switching device.

### BRIEF DESCRIPTION OF THE DRAWINGS

Other features and advantages of the disclosure will become readily apparent to those skilled in the art from the following detailed description of the embodiments in the light of the accompanying drawings, in which:

FIG. 1 is a perspective view of a first embodiment of the present disclosure, illustrating its integration with a conventional rotor;

FIG. 2 is a cross-sectional view taken along the direction 2-2 of FIG. 1;

FIG. 3 is an enlarged schematic view of section A in FIG. 2, illustrating the arrangement of the first winding in the first portion of the slot and the second winding in the second portion of the slot;

FIG. 4 is a circuit diagram of the stator winding unit and the first switching device of the first embodiment wherein the stator winding unit is connected in a wye configuration;

FIG. 5 is a circuit diagram of the stator winding unit and the first switching device of the first embodiment according to the present disclosure, wherein the stator winding unit is connected in a delta configuration;

FIG. 6 is a block diagram illustrating the electrical connections between the stator winding unit, the first switching device, the electrical control unit and the AC power source in the first embodiment;

FIG. 7 is an enlarged schematic view of the same position as FIG. 3, showing a second embodiment wherein the first winding installed in the second portion of the slot and the second winding installed in the first portion of the slot;

FIG. 8 is a block diagram illustrating the electrical connections of a third embodiment according to the present disclosure;

FIG. 9 is a circuit diagram of a single-phase motor in which the stator assembly is implemented according to another aspect of the present disclosure;

FIG. 10 is a block diagram illustrating the electrical connections of the stator assembly depicted in FIG. 9; and

FIG. 11 is a block diagram illustrating the electrical connections of another embodiment of the stator assembly depicted in FIG. 9.

### DETAILED DESCRIPTION

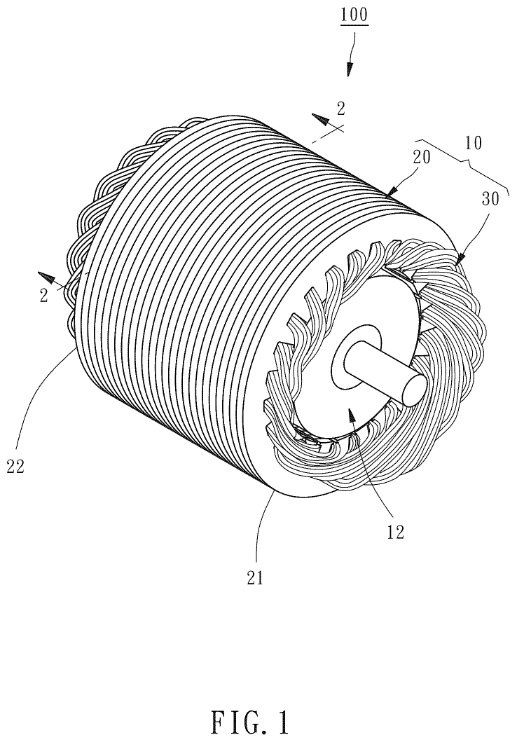

Referring firstly to FIG. 1 through FIG. 6, a first embodiment of a stator assembly according to the disclosure, designated by reference number 10, is disclosed. This stator assembly 10 is designed for use in a three-phase AC motor 100. The three-phase AC motor 100 further includes a rotor 12 positioned within the stator assembly 10.

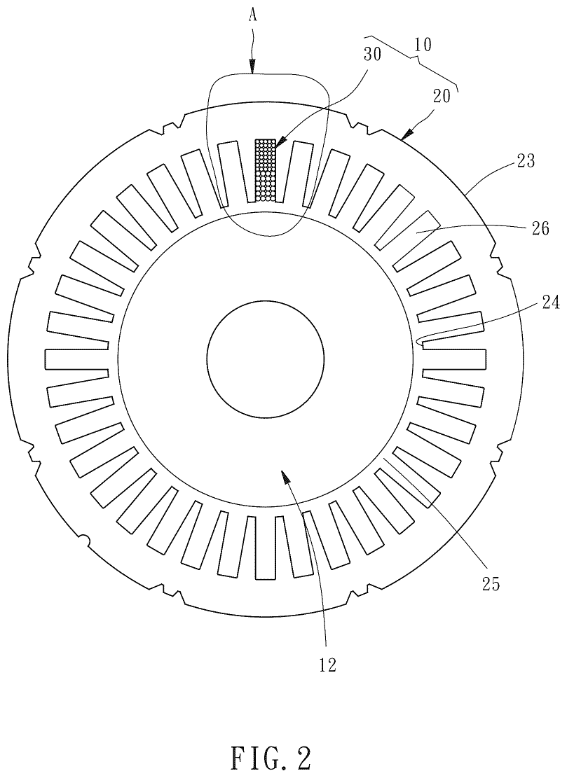

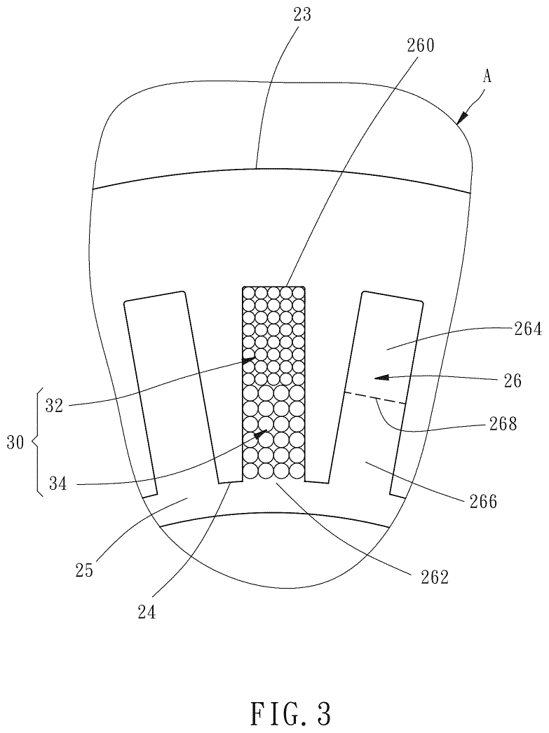

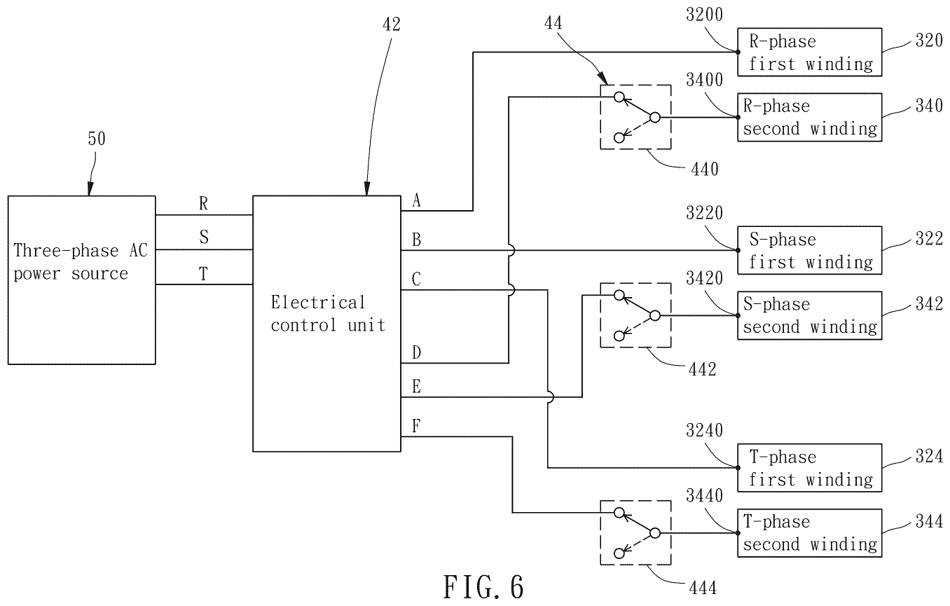

The stator assembly 10, as shown in FIG. 2, comprises a generally cylindrically-shaped stator core 20, a stator winding unit 30, an electrical control unit 42 and a first three-phase switching device 44, as shown in FIG. 6. The stator core 20, in this embodiment, is constructed by stacking a plurality of annular silicon-steel sheets, forming a cylindrical shape. The stator core 20 includes a first and second axial ends 21, 22, an outer peripheral surface 23, an inner peripheral surface 24 and a through hole 25 and a plurality of slots 26 extending through it in the axial direction and arranged side-by-side in the circumferential direction. The through hole 25 accommodates the rotor 12. Each of the slots 26, as shown in FIG. 3, includes a closed bottom 260 located near the outer peripheral surface 23 of the stator core 20, an open top 262 located near the inner peripheral 24 surface of the stator core 20. Furthermore, each of the slots 26 is conceptually divided by a virtual dividing line 268 into a first portion 264 near the closed bottom 260 and a second portion 266 near the open top 262.

The stator winding unit 30 is installed in the slots 26 of the stator core 20. As shown in FIG. 2, only one slot 26, containing a portion of the stator winding unit 30, is illustrated for clarity. The stator winding unit 30 includes a first winding 32 installed in the first portion 264 and a second winding 34 installed in the second portion 266. The first winding 32 includes a first electrical conductor with a first electric electrical conductivity and a first rated output power under given conditions. The second winding 34 includes a second electrical conductor with a second electric electrical conductivity smaller than the first electric electrical conductivity and a second rated output power smaller than or equal to the first rated output power under the given conditions. In some embodiments, the first electrical conductor comprises copper materials, while the second electrical conductor comprises aluminum materials. For a motor with a rated output power of 3 HP, both the first and second windings can have a rated output power of up to 3 HP.

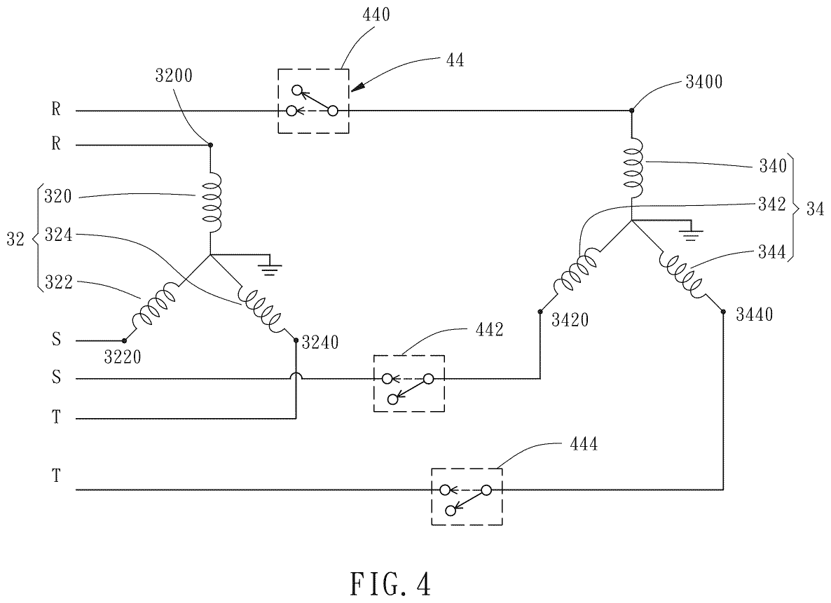

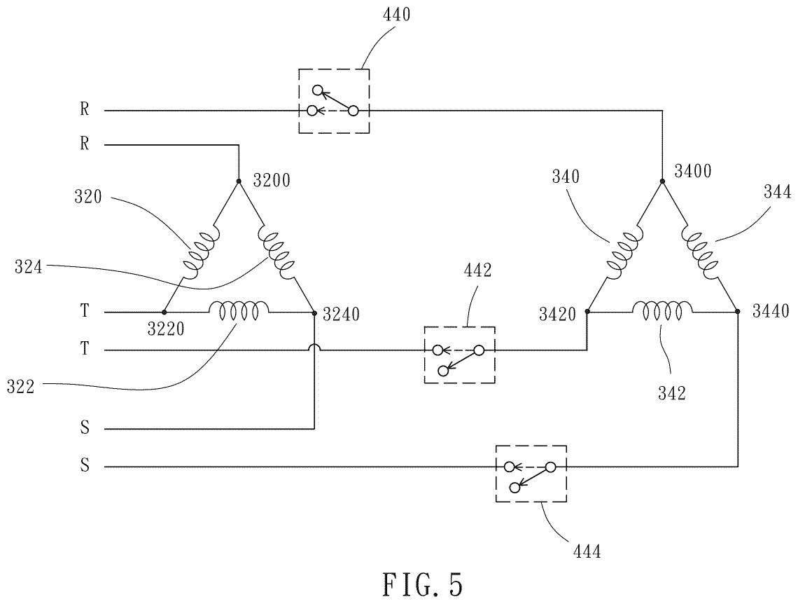

In this embodiment, as shown in FIG. 4 and FIG. 5, the first winding 32 includes a first R phase winding 320 having a first terminal 3200, a first S phase winding 322 having a second terminal 3220, and a first T phase winding 324 having a third terminal 3240. The first R phase winding 320, the first S phase winding 322, and the first T phase winding 324 are connected in either a wye configuration, as shown in FIG. 4, or a delta configuration, as shown in FIG. 5. The second winding 34 includes a second R phase winding 340 having a first terminal 3400, a second S phase winding 342 having a second terminal 3420, and a second T phase winding 344 having a third terminal 3440. The second R phase winding 34, the second S phase winding 342, and the second T phase winding are connected in either a wye configuration, as shown in FIG. 4, or a delta configuration, as shown in FIG. 5. The first switching device 44 includes a R-phase first switching device 440, a S-phase first switching device 442, and a T-phase first switching device 444.

The electrical control unit 42 is typically implemented as a specific computer program, such as a programmable logic controller (PLC). In the electrical connection, as shown in FIG. 6, the first terminal 3200, the second terminal 3220, and the third terminal 3240 of the first winding 32 are connected to the electrical control unit 42 via branches A, B, and C, respectively. Additionally, the electrical control unit 42 is connected to the R-phase, S-phase, and T-phase output terminals of the three-phase AC power source 50. The first terminal 3400, the second terminal 3420, and the third terminal 3440 of the second winding 34 are connected to the R-phase first switching device 440, the S-phase first switching device 442, and the T-phase first switching device 444, respectively. These switching devices 440, 442, and 444 are in turn connected to the electrical control unit 42 via branches D, E, and F respectively.

During operation, when the motor 100 starts under a predetermined load, the electrical control unit 42 closes the R-phase, S-phase, and T-phase first switching devices 440, 442, 444. This configuration connects both the first winding 32 and the second winding 34 to the three-phase AC power source 50, combining their rated output powers to drive the motor 100. As the motor 100 approaches a predetermined speed, the electrical control unit 42 opens the R-phase, S-phase, and T-phase first switching devices 440, 442, 444, disconnecting the AC power source 50 from the second winding 34 and leaving it connected exclusively to the first winding 32. Consequently, the motor 100 operates with only the first winding's rated output power.

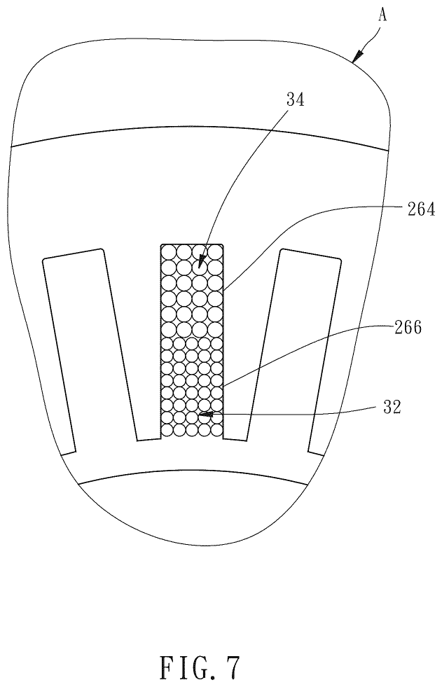

Referring now to FIG. 7, in a second embodiment, the arrangement of the windings within the slot 26 is reversed. The first winding 32 is installed in the second portion 266 of the slot 26, while the second winding 34 is installed in the first portion 264 of the slot 26.

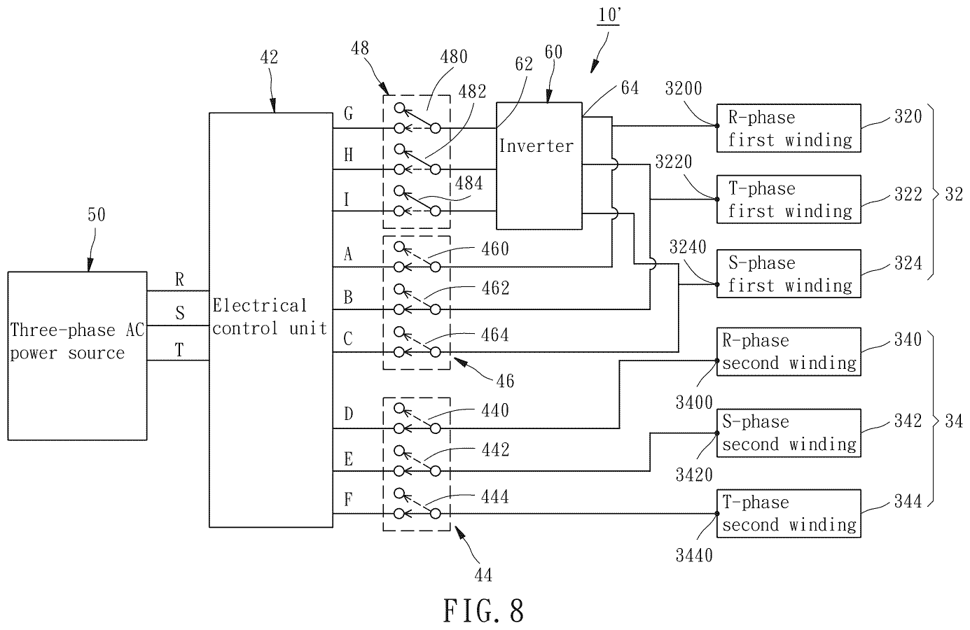

Referring to FIG. 8, a block diagram illustrates the electrical connections of a third embodiment, denoted as 10', according to the present disclosure. The third embodiment 10′ is a design intended for use when a motor needs to operate in conjunction with an inverter. It avoids using a high-power inverter during startup and instead employs only a lower-power inverter during normal operation. As a result, it not only reduces manufacturing costs but also effectively saves energy. The inverter mentioned here can also be referred to as a Variable Frequency Drive (VFD).

The primary difference between the stator assembly 10′ and the stator assembly 10 is that the stator assembly 10′ further includes an inverter 60, a second switching device 46 having a R-phase second switching device 460, a S-phase second switching device, and a T-phase second switching device 464, and a third switching device 48 having a R-phase third switching device 480, a S-phase third switching device 482, and a T-phase third switching device 484. The first terminal 3200, the second terminal 3220, and the third terminal 3240 of the second winding 32 are respectively connected to the R-phase second switching device 460, the S-phase second switching device 462, and the T-phase second switching device 464 of the second switching device 46. The inverter 60 has input terminals 62 connected to the third switching device 48 and output terminals 64 connected to the first terminal 3200, second terminal 3220, and third terminal 3240 of the first winding 32. Additionally, the R-phase, S-phase, and T-phase third switching devices 480, 482, and 484 of the third switching device 48 are connected to the electrical control unit 42 via branches G, H, and I, respectively.

During the motor's startup phase, the electrical control unit 42 closes the first and second switching devices 44, 46, while keeping the third switching device 48 open. This configuration connects the first and second windings (32, 34) to the AC power source 50, combining their rated output powers to drive the motor. Once the motor reaches a predetermined speed, the electrical control unit 42 opens the first and second switching devices 44, 46 and closes the third switching device 48. In this state, the AC power source 50 connects exclusively to the first winding 32 through the inverter 60, enabling the motor to operate under the inverter's control.

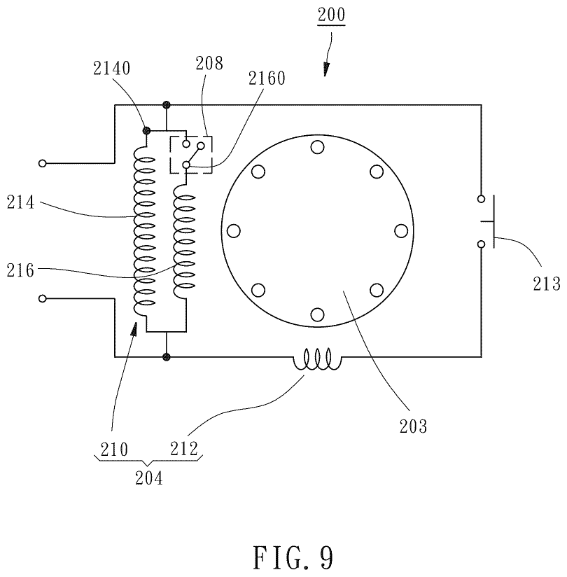

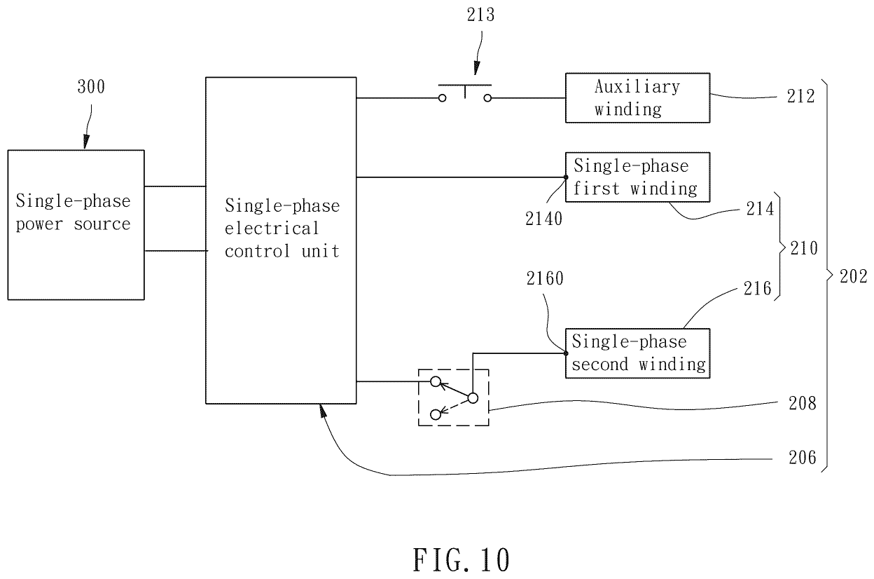

Referring next to FIG. 9 and FIG. 10, FIG. 9 illustrates a circuit diagram of a single-phase motor 200. The motor 200 comprises a stator assembly 202 and a rotor 203, where the stator assembly 202 is implemented according to another aspect of the present disclosure. FIG. 10 provides a block diagram detailing the electrical connections of the stator assembly 202 depicted in FIG. 9.

The stator assembly 202 includes a stator winding unit 204, an electrical control unit 206, and a first single-phase switching device 208. The stator winding unit 204 includes a main winding 210 and an auxiliary winding 212. The main winding 210 includes a first single-phase winding 214 having a first electrical conductor with a first electric electrical conductivity and a first rated output power under given conditions and a second single-phase winding 216 having a second electrical conductor with a second electrical conductivity and a second rated output power under the given conditions, wherein the first rated output power is greater than or equal to the second rated output power, and the first electric electrical conductivity is greater than the second electric electrical conductivity. The auxiliary winding 212 is connected to electrical control unit 206 via a centrifugal switch 213. The first single-phase winding 214 has a first terminal 2140 connected to the single-phase electrical control unit 206 and the second single-phase winding 216 has a second terminal 2160 connected to the single-phase electrical control unit 214 via the first single-phase switching device 208. The single-phase electrical control unit 206 is connected to a single phase power source 300.

In operation, when the motor 200 starts under a predetermined load, the first single-phase switching device 208 is kept in a closed state by the single-phase electrical control unit 206. This configuration connects both the first single-phase winding 214 and the second single-phase winding 216 to the single-phase power source 300, combining their rated output powers to drive the motor.

As the motor 200 approaches a predetermined speed, the first single-phase switching device 208 is controlled by the single-phase electrical control unit 206 to switch to an open state. In this state, the power source 300 connects exclusively to the first single-phase winding 214, enabling the motor to output only the first rated power.

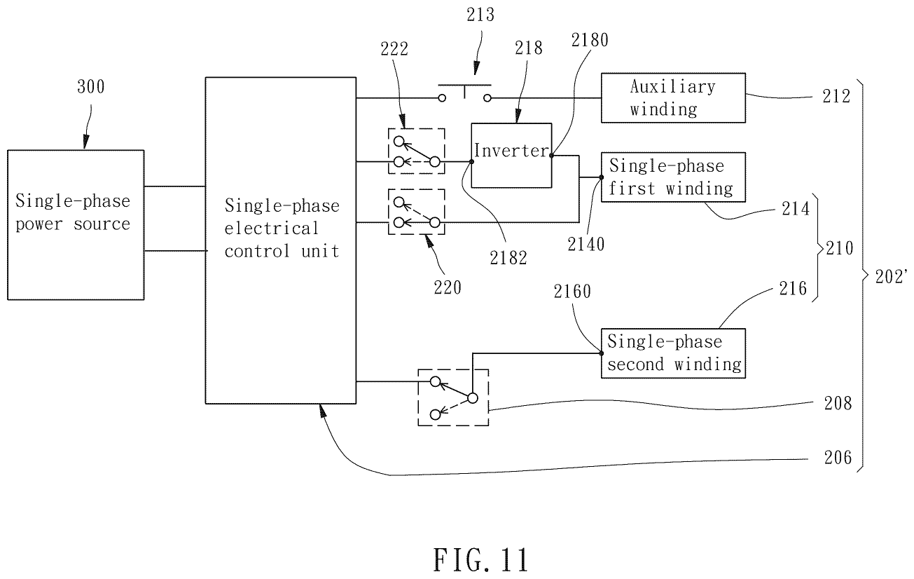

Lastly, referring to FIG. 11, it is a block diagram illustrating the electrical connections of another embodiment of the stator assembly depicted in FIG. 9 and denoted as 202'.

The primary difference between the stator assembly 202′ and the stator assembly 202 is that the stator assembly 202′ further includes an inverter 218, a second single-phase switching device 220 and a third single-phase switching device 222. The inverter 218 has an output terminal 2180 connected to the first terminal 2140 of the single-phase first winding 214 and an input terminal 2182 connected to the single-phase electrical control unit 206 via the third single-phase switching device 222. Additionally, the first terminal 2140 of the single-phase first winding 214 is connected to the single-phase electrical control unit 206 via the second single-phase switching device 220.

In operation, when the motor 200 starts under a predetermined load, the first and second single-phase switching devices 208, 220 remain closed under the control of the single-phase electrical control unit 206. This configuration connects the first and second single-phase windings 214, 216 to the single-phase power source 300, combining their rated output powers to drive the motor. Once the motor 200 reaches a predetermined speed, the single-phase electrical control unit 206 opens the first and second switching devices 208, 220 and closes the third single-phase switching device 222. In this state, the single-phase power source 300 is connected exclusively to the first single-phase winding 214 via the inverter 218, allowing the motor 200 to operate under the inverter's control.

Overall, the motors disclosed herein provide the following advantages:
Energy Conservation during Stable Operation: High power is utilized during startup to overcome load inertia. Once stable operation is achieved, reducing power output significantly conserves energy as the load demand decreases.

Prevention of Overloading: Sufficient power during startup ensures adequate torque, effectively preventing motor overloading.

Reduced Long-term Operating Costs: Operating at a low-power state for extended periods minimizes energy consumption, lowering overall operating costs.

Extended Service Life: Reducing power output during normal operation minimizes internal losses, decreases operating temperature, and prolongs the motor's lifespan.

Cost-efficient Winding Design: The primary winding (or single-phase first winding), which operates continuously, utilizes high-efficiency copper wire. The secondary winding (or single-phase second winding), used only for startup torque, employs cost-effective aluminum wire, effectively reducing manufacturing costs.

Simplified Inverter Usage: Instead of relying on a high-power inverter during startup, the system uses a lower-power inverter during normal operation, reducing both manufacturing costs and energy consumption.

What is claimed is:

1. A stator assembly of a motor, comprising:
a stator core;
at least one stator winding unit installed in the stator core to generate kinetic energy in cooperation with a rotor of the motor;
a first switching device;
the stator winding unit comprising:
a first winding including a first electrical conductor with a first electrical conductivity and a first rated output power under given conditions;
a second winding including a second electrical conductor with a second electrical conductivity and a second rated output power under the same conditions;
wherein the first rated output power is greater than or equal to the second rated output power, and the first electrical conductivity is greater than the second electrical conductivity; the first winding is electrically connected to an AC power source, while the second winding is electrically connected to the AC power source via the first switching device;
whereby, during the motor's startup phase, the first switching device is closed, connecting both the first and second windings to the AC power source, thereby combining their rated output powers as the motor's total output, once the motor reaches a predetermined speed, the first switching device opens, leaving the AC power source connected only to the first winding, allowing the motor to operate at its first rated output power.

2. The stator assembly of a motor of claim 1, wherein the first electrical conductor comprises copper materials and the second electrical conductor comprises aluminum materials.

3. The stator assembly of a motor of claim 1, further comprising an electrical control unit having an input end connected to the AC power source and an output end having first branch connected to the first winding and a second branch connected the second winding via the first switching device.

4. The stator assembly of a motor of claim 3, further including an inverter, a second switching device and a third switching device, wherein the inverter has an input end connected to the third switching device and an output end connected to the first winding, the second switching device is connected between the inverter and the electrical control unit, the third switching device is connected between the first winding and the electrical control unit; whereby, during the motor's startup phase, the first and third switching devices are closed, and the second switching device is open, connecting both the first and second windings to the AC power source to combine their rated output powers as the motor's total output; once the motor reaches a predetermined speed, the first and third switching devices are opened, and the second switching device is closed, leaving the AC power source connected only to the first winding via the inverter to allow the motor to operate under the control of the inverter.

5. A stator assembly of a motor, comprising:
a stator core;
a stator winding unit installed in the stator core to generate kinetic energy in cooperation with a rotor of the motor;
the stator winding unit comprising:
a first winding including a first electrical conductor with a first electrical conductivity, and a first rated output power under given conditions,
a second winding including a second electrical conductor with a second electrical conductivity, and a second rated output power under the given conditions; and
a first three-phase switching device;
wherein the first rated output power is greater than or equal to the second rated output power, and the first electrical conductivity is greater than the second electric electrical conductivity,
wherein the first three-phase switching device includes a first R-phase switching device, a first S-phase switching device, and a first T-phase switching device;
wherein the first winding includes a first R-phase winding having a first terminal for electrically connecting to a R-phase end of a three-phase AC power source, a first S-phase winding having a second terminal for electrically connecting to a S-phase end of the three-phase AC power source, and a first T-phase winding having a third terminal for electrically connecting to a T-phase end of the three-phase AC power source, the first R-phase winding, the first S-phase winding, and the first T-phase winding are connected in either a wye configuration or a delta configuration; and
wherein the second winding includes a second R-phase winding having a first terminal for electrically connecting to the R-phase end of the three-phase AC power source via the first R-phase switching device, a second S-phase winding having a second terminal for electrically connecting to the S-phase end of the three-phase AC power source via the second S-phase switching device, and a second T-phase winding having a third terminal for electrically connecting to the T-phase end of the three-phase AC power source via the first T-phase switching device, the second R-phase winding, the second S-phase winding and the second T-phase winding are connected in either a wye configuration or a delta configuration;
whereby, during the start-up stage of the motor, all the switching devices are closed, allowing the AC power source to connect to both the first and second windings simultaneously, providing a combined output power to the motor; as the motor approaches a predetermined speed, all the switching devices open, enabling the AC power source to source power only to the first winding, which outputs the first rated power externally.

6. The stator assembly of a motor of claim 5, wherein the first rated output power of the first winding is equal to the rated output power of the motor.

7. The stator assembly of a motor of claim 5, wherein the stator core has a cylindrical shape with a plurality of slots extending through it in the axial direction and arranged side-by-side in the circumferential direction.

8. The stator assembly of a motor of claim 7, wherein the first winding and the second winding are installed within the same slot of the stator core.

9. The stator assembly of a motor of claim 7, wherein each of the slots includes a closed bottom near an outer peripheral surface of the stator core and an open top near an inner peripheral surface of the stator core, and each of the slots is further divided into a first portion located near the closed bottom and a second portion located near the open top.

10. The stator assembly of a motor of claim 5, further comprising an electrical control unit having an input end connected to the AC power source and an output end having first branches connected respectively to each phase's first winding and second branches connected respectively to each phase's second winding via each phase's first switching device.

11. The stator assembly of a motor of claim 5, further comprising an inverter, a second three-phase switching device, and a third three-phase switching device, wherein the inverter has an input end connected to the third three-phase switching device and an output end connected to the first winding, the second three-phase switching device is connected between the first winding and the AC power source, the third three-phase switching device is connected between the inverter and the AC power source;
whereby, during the motor's startup phase, the first and second three-phase switching devices are closed, and the third three-phase switching device is open, connecting both the first and second windings to the AC power source, combining their rated output powers to serve as the motor's total output; once the motor reaches a predetermined speed, the first and second three-phase switching devices are opened, and the third three-phase switching device is closed, leaving the AC power source connected only to the first winding through the inverter, allowing the motor to operate under the control of the inverter.

12. A method for assembling a stator assembly of a motor, comprising the following steps:
providing a stator core,
selecting a stator winding unit installed in the stator core to generate kinetic energy in cooperation with a rotor of the motor;
providing a first switching device;
wherein the stator winding unit comprises:
a first winding including first electrical conductors with a first electric electrical conductivity and a first rated output power under given conditions,
a second winding including second electrical conductors with a second electrical conductivity lower than the first electrical conductivity and a second rated output power lower than or equal to the first rated output power under the same given conditions,
electrically connecting the first winding to an AC power source; and
electrically connecting the second winding to the AC power source via the first switching device.

13. A method for assembling a stator assembly of a motor, comprising the following steps:
providing a stator core;
selecting a stator winding unit installed in the stator core to generate kinetic energy in cooperation with a rotor of the motor;
the stator winding unit comprising:
a first winding including a first electrical conductor with a
first electrical conductivity, a first rated output power under given conditions,
a second winding including a second electrical conductor with a second electrical conductivity and a second rated output power under the given conditions;
and
a first three-phase switching device;
wherein the first rated output power is greater than or equal to second rated output power, and the first electrical conductivity is greater than the second electric electrical conductivity,
wherein the first three-phase switching device includes a R-phase first switching device, a S-phase first switching device, and a T-phase first switching device;
wherein the first winding includes a R-phase first winding having a first terminal for electrically connecting to a R-phase end of a three-phase AC power source, a S-phase first winding having a second terminal for electrically connecting to a S-phase end of the three-phase AC power source, and a T-phase first winding having a third terminal for electrically connecting to a T-phase end of the three-phase AC power source, the R-phase first winding, the S-phase first winding, and the T-phase first winding are connected in either a wye configuration or a delta configuration; and
wherein the second winding includes a R-phase second winding having a first terminal for electrically connecting to the R-phase end of the three-phase AC power source via the R-phase first switching device, a S-phase second winding having a second terminal for electrically connecting to the S-phase end of the three-phase AC power source via the S-phase second switching device, and a T-phase second winding having a third terminal for electrically connecting to the T-phase end of the three-phase AC power source via the T-phase first switching device, the R-phase second winding, the S-phase second winding and the T-phase second winding are connected in either a wye configuration or a delta configuration;
whereby, during the start-up stage of the motor, all the switching devices are closed, allowing the AC power source to connect to both the first and second windings simultaneously, providing a combined output power to the motor; as the motor approaches a predetermined speed, all the switching devices open, enabling the AC power source to source power only to the first winding, which outputs the first rated power externally.

14. The method for assembling a stator assembly of a motor of claim 13, further comprising the following steps:
providing an inverter,
providing a second three-phase switching device having a R-phase second switching device, a S-phase second switching device, and a T-phase second switching device,
providing a third three-phase switching device having a R-phase third switching device, a S-phase third switching device, and a T-phase third switching device,
electrically connecting the R-phase first winding, the S-phase first winding, and the T-phase first winding of the first winding to the AC power source via the R-phase second switching device, the S-phase second switching device, and the T-phase second switching device of the second switching device respectively,
electrically connecting the R-phase first winding, the S-phase first winding, and the T-phase first winding of the first winding to an output end of the inverter respectively, and electrically connecting an input end of the inverter to the AC power source via the R-phase third switching device, the S-phase third switching device, and the-phase third switching device of the third switching device respectively,
whereby, during the motor's startup phase, the first and second three-phase switching devices are closed, and the third three-phase switching device is open, connecting both the first and second windings to the AC power source, combining their rated output powers to serve as the motor's total output, once the motor reaches a predetermined speed, the first and second three-phase switching devices are open, and the third three-phase switching device is closed, leaving the AC power source connected only to the first winding via the inverter to leave the AC power source connected only to the first winding through the inverter, allowing the motor to operate under the control of the inverter.

15. The method for assembling a stator assembly of a motor of claim 13, wherein the first rated output power of the first winding is equal to the rated output power of the motor.

16. The method for assembling a stator assembly of a motor of claim 14, wherein the first electrical conductor comprises copper materials, and the second electrical conductor comprises aluminum materials.

17. The method for assembling a motor stator assembly of claim 13, wherein the stator core has a cylindrical shape with a plurality of slots extending through it in the axial direction and arranged side-by-side in the circumferential direction.

18. The method for assembling a motor stator assembly of claim 17, wherein the first winding and the second winding are installed within the same slot.

19. The method for assembling a motor stator assembly of claim 17, wherein each of the slots includes a closed bottom near an outer peripheral surface of the stator core and an open top near an inner peripheral surface of the stator core, and each of the slots is further divided into a first portion located near the closed bottom and a second portion located near the open top.
